(19) United States
(12) Patent Application Publication
(10) Pub. No.: US 2025/0192703 A1
(43) Pub. Date: Jun. 12, 2025

(54) POWER SUPPLY DEVICE

(71) Applicant: FUJI ELECTRIC CO., LTD., Kawasaki-shi (JP)

(72) Inventor: Sachio TAKANO, Tokyo (JP)

(73) Assignee: FUJI ELECTRIC CO., LTD., Kawasaki-shi (JP)

(21) Appl. No.: 19/062,918

(22) Filed: Feb. 25, 2025

Related U.S. Application Data
(63) Continuation of application No. PCT/JP2023/037655, filed on Oct. 18, 2023.

(30) Foreign Application Priority Data
Oct. 20, 2022 (JP) 2022-168557

(51) Int. Cl. H02P 9/00

(52) U.S. Cl. CPC H02P 9/006

(57) ABSTRACT

A power supply device, for simulating a synchronous generator and controlling a frequency of an output voltage, including: a determination unit configured to determine whether an accident occurs in a power system; a command frequency output unit configured to output a command frequency that reduces a difference between a first power that is a target to be provided to or received from the power system and a second power that is being provided to or received from the power system, when the power system is in a normal state, and output, irrespective of the difference, a predetermined command frequency, responsive to an occurrence of the accident; a generation unit configured to generate a control signal for controlling the output voltage, based on the command frequency; and a drive unit configured to output the output voltage generated based on the control signal, to the power system.

### CROSS-REFERENCE TO RELATED APPLICATIONS

This is a continuation application of International Patent Application No. PCT/JP2023/037655 filed Oct. 18, 2023, which claims the benefit of priority to Japanese Patent Application No. 2022-168557 filed Oct. 20, 2022, the entire contents of each of which the entire contents of each of which are incorporated herein by reference.

### BACKGROUND

### Technical Field

The present disclosure relates to a power supply device.

### Description of the Related Art

A synchronous generator contributes to the maintenance of the frequency of a power system by the inertia of a rotor. In recent years, a pseudo-synchronous generator that simulates a synchronous generator by controlling output of an inverter is known (for example, Japanese Patent No. 7023430).

In a time period during which a voltage of a power system has dropped due to an accident occurring in the power system, in general, the absolute value of a power to be inputted/outputted by a pseudo-synchronous generator decreases. Due to such a decrease, the frequency of an output voltage of the pseudo-synchronous generator starts to increase irrespective of the frequency of the power system in some cases.

This causes a deviation between the phase of the voltage of the power system and the phase of the output voltage of the pseudo-synchronous generator. When the phase difference reaches 180 degrees or more, in particular, the pseudo-synchronous generator falls in a state of being unable to be restored to a state of being synchronized with the power system by itself, i.e., a step-out, in some cases.

Countermeasures against such a step-out for the pseudo-synchronous generator described in Japanese Patent No. 7023430 are not disclosed therein.

The present disclosure is directed to provision of a power supply device capable of preventing a step-out due to an accident occurring in a power system or the like.

### SUMMARY

An aspect of the present disclosure is a power supply device that simulates a synchronous generator including a rotor and controls a frequency of an output voltage thereof to control a power provided to or received from a power system, the power supply device including: a processor, and a non- transitory storage medium having program instructions stored thereon, execution of which by the processor causes the power converter to provide functions of: a determination unit configured to determine whether an accident occurs in the power system; a command frequency output unit configured to: output a command frequency that reduces a difference between a first power that is a target power to be provided to or received from the power system, and a second power that is a power being provided to or received from the power system, when the power system is in a normal state, and output, irrespective of the difference, a predetermined command frequency, responsive to an occurrence of the accident in the power system; a generation unit configured to generate a control signal for controlling the output voltage, based on an output of the command frequency output unit; and a drive unit configured to generate the output voltage based on the control signal.

Another aspect of the present disclosure is a power supply device that simulates a synchronous generator including a rotor and controls a frequency of an output voltage thereof, to control a power provided to or received from a power system, the power supply device including: a processor, and a non-transitory storage medium having program instructions stored thereon, execution of which by the processor causes the power converter to provide functions of: a determination unit configured to determine whether an accident occurs in the power system; a command frequency output unit configured to: output a command frequency that reduces a difference between a first power that is a target power to be provided to or received from the power system, and a second power that is the power being provided to or received from the power system, based on the first power, the second power, and an inertia constant for simulating the rotor; a generation unit configured to generate a control signal for controlling the output voltage, based on the command frequency; and a drive unit configured to generate the output voltage based on the control signal, and to output the output voltage to the power system, wherein the command frequency output unit is configured to control, responsive to an occurrence of the accident in the power system, at least one of the first power and the inertia constant, to suppress a change of the command frequency.

Other features of the present disclosure will become apparent from the descriptions of the present description.

According to the present disclosure, it is possible to provide a power supply device capable of preventing a step-out due to an accident occurring in a power system or the like.

### BRIEF DESCRIPTION OF DRAWINGS

FIG. 1 is a diagram illustrating an example of a power system 1 provided with a power supply device 2.

FIG. 2 is a diagram illustrating an example of functional blocks of the power supply device 2 provided in the power system 1.

FIG. 3 is a diagram illustrating a simulation unit 21 of the power supply device 2.

FIGS. 4A to 4D provide graphs illustrating a step-out in the power supply device 2.

FIGS. 5A to 5D provide graphs illustrating a numerical simulation result assuming that a power supply device has an interconnection with a power system.

FIG. 6 is a diagram illustrating a simulation unit 31 of a power supply device 3.

FIGS. 7A and 7B provide graphs illustrating a value A that is outputted from an output unit 312 of the power supply device 3.

FIGS. 8A to 8D provide graphs illustrating a numerical simulation result assuming that the power supply device 3 has an interconnection with a power system.

FIG. 9 is a diagram illustrating a simulation unit 41 of a power supply device 4.

FIGS. 10A and 10B provide graphs illustrating variation of an inertia constant M.

FIG. 11 is a diagram illustrating a simulation unit 51 of a power supply device 5.

FIGS. 12A and 12B provide graphs illustrating a value that is outputted from a restriction unit 511 of the power supply device 5.

FIG. 13 is a diagram illustrating a simulation unit 61 of a power supply device 6.

### DETAILED DESCRIPTION

### First Embodiment

### <<Power Supply Device>>

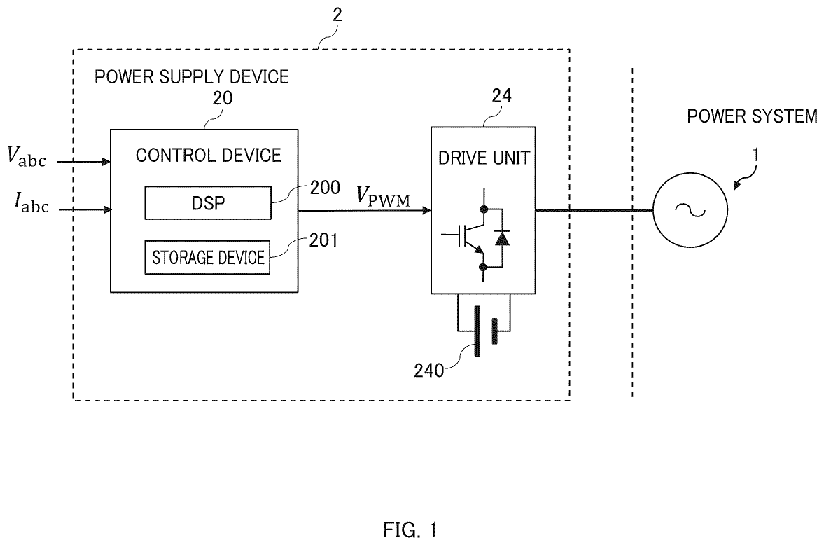

FIG. 1 is a diagram illustrating an example of a power system 1 provided with a general power supply device 2. The power supply device 2 is a so-called pseudo-synchronous generator that simulates a synchronous generator including a rotor.

The power supply device 2 is a device that controls the frequency of an output voltage V_{abc}, to control a power Pₒᵤₜ provided to or received from the power system 1.

Here, the output voltage V_{abc} collectively represents phase voltages Vₐ, V_{b}, and V_{c} of the respective phases in the three-phase alternating current.

The power Pₒᵤₜ is a power that is a power being actually provided to or received from the power system 1. When the power Pₒᵤₜ is positive, the power Pₒᵤₜ is a power that is outputted from the power supply device 2 to the power system 1. When the power Pₒᵤₜ is negative, the power Pₒᵤₜ is a power that is inputted from the power system 1 to the power supply device 2.

The power supply device 2 includes a control device 20 and a drive unit 24. In the following, firstly, a hardware configuration of the control device 20 will be described, and then functional blocks of the power supply device 2 will be described.

### <Hardware Configuration of Control Device 20>

The control device 20 includes a digital signal processor (DSP) 200 and a storage device 201 (FIG. 1).

### <DSP 200>

The DSP 200 executes a predetermined program stored in the storage device 201 to implement various functions of the control device 20.

### <Storage Device 201>

The storage device 201 includes a non-temporary (for example, nonvolatile) storage device that stores various kinds of data to be executed or processed by the DSP 200.

The storage device 201 further includes, for example, a random-access memory (RAM) or the like and is used as a temporary memory area for various programs, data, and the like.

### <Functional Blocks of Power Supply Device 2>

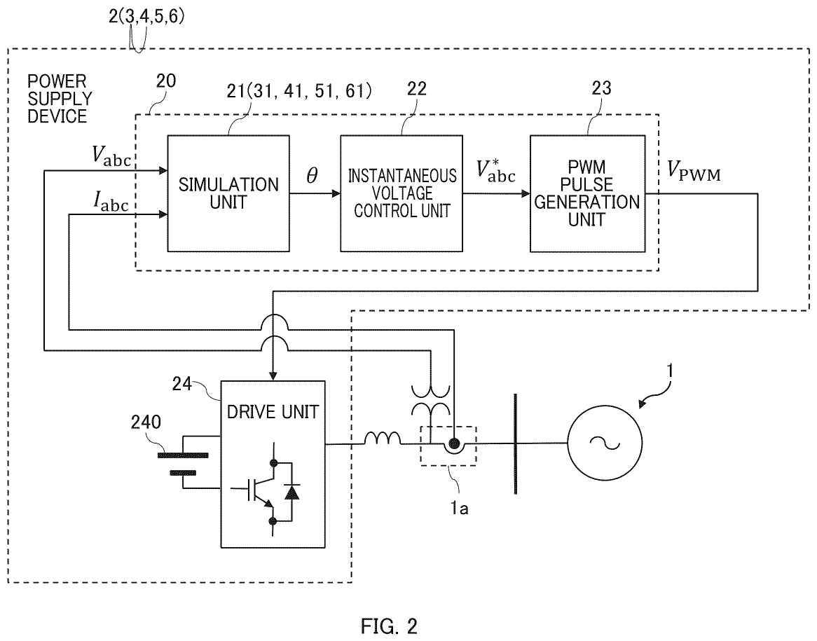

FIG. 2 is a diagram illustrating an example of functional blocks of a power supply device provided in the power system 1.

Note that, in the following, functional blocks of the power supply device 2 will be described first. Reference numerals in the parentheses given to the power supply device 2 in FIG. 2 will be described separately.

As a result of the DSP 200 executing a predetermined program, a simulation unit 21, an instantaneous voltage control unit 22, and a PWM pulse generation unit 23 are implemented in the control device 20. Consequently, the power supply device 2 includes the simulation unit 21, the instantaneous voltage control unit 22, the PWM pulse generation unit 23, and the drive unit 24. In the following, these units will be described individually.

Note that, when the same reference numeral is given to blocks in the drawings, those blocks are the same.

### <Simulation Unit 21>

The simulation unit 21 simulates a synchronous generator to calculate a phase θ, which is a command value for the phase of the output voltage V_{abc} that is outputted to the power system 1.

Specifically, the simulation unit 21 outputs the phase θ, which is the command value for the output voltage V_{abc}, by taking, as inputs, the output voltage V_{abc} that is measured at an interconnection point 1a (FIG. 2) and an output current I_{abc} that is measured at the interconnection point 1a.

In the following description, an inertia constant M refers to an inertia constant of a rotor in the synchronous generator that is simulated by the simulation unit 21. The inertia constant M is a parameter for simulating the difficulty of the rotor in response to external force. That is, the larger the inertia constant M is, the more difficult it is for the rotor to change a rotational speed thereof around a given axis, which causes the difficulty in accelerating and decelerating. Note that the inertia constant M is a parameter corresponding to an inertia moment.

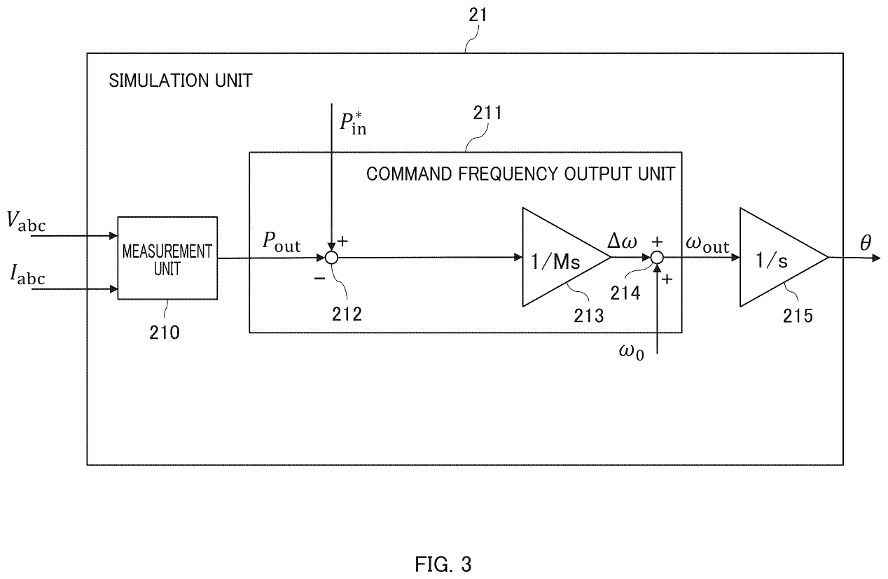

FIG. 3 is a diagram illustrating the simulation unit 21 of the power supply device 2. The simulation unit 21 includes a measurement unit 210, a command frequency output unit 211, and an integrator 215. Processing executed by each of the components in the simulation unit 21 will be described below.

### <Measurement Unit 210>

The measurement unit 210 multiplies together the output voltage V_{abc} and the output current I_{abc} that are measured at the interconnection point 1a to obtain the power Pₒᵤₜ.

### <<Command Frequency Output Unit 211>>

The command frequency output unit 211 outputs a command frequency that reduces the difference (Pᵢₙ*−Pₒᵤₜ) between the power Pᵢₙ* and the power Pₒᵤₜ, based on such a difference. The power Pᵢₙ* is a power that is a target power to be provided to or received from the power system 1. The power Pᵢₙ* may be the value of a power that is predetermined by a user or the like of the power supply device 2 and stored in the storage device 201, or given by communication from a higher command device or the like.

Note that the above-mentioned “command frequency that reduces the difference (Pᵢₙ*−Pₒᵤₜ)” is simply required to be a command frequency for converging to a steady state where the difference (Pᵢₙ*−Pₒᵤₜ) is 0 (zero) after the difference (Pᵢₙ*−Pₒᵤₜ) has fluctuated due to an accident or the like which will be described later.

Hence, during a transitional time period such as immediately after the fluctuation of the difference (Pᵢₙ*−Pₒᵤₜ), the command frequency output unit 211 may output a command frequency that increases the difference (Pᵢₙ*−Pₒᵤₜ).

The command frequency output unit 211 includes a subtraction unit 212, an integrator 213, and an addition unit In the following, these units will be described 214. individually.

### <Subtraction Unit 212>

The subtraction unit 212 executes processing of subtracting the power Pₒᵤₜ from Pᵢₙ* and then outputs the resultant to the integrator 213.

### <Integrator 213>

The integrator 213 executes processing of time-integrating a value obtained by dividing a subtraction result (Pᵢₙ*−Pₒᵤₜ), which is an input from the subtraction unit 212, by the inertia constant M, during a predetermined time period.

The integrator 213 outputs a value Δω obtained by such an operation, to the addition unit 214. The value Δω corresponds to a value obtained by dividing, by the inertia constant M, energy accumulated in the rotor during the predetermined time period of the time-integration performed by the integrator 213, when the value Δω is linearly approximated around 0 (zero).

### <Addition Unit 214>

The addition unit 214 executes processing of adding the value Δω, which is an output from the integrator 213, and a predetermined frequency ω₀. Consequently, the addition unit 214 outputs a command frequency ωₒᵤₜ (=ω₀+Δω) for the output voltage V_{abc} that is outputted to the power system 1. The command frequency Wₒᵤₜ is a value that reduces the subtraction result (Pᵢₙ*−Pₒᵤₜ) from the subtraction unit 212.

Here, the predetermined frequency ω₀ refers to a rated frequency of the power system 1 in the present embodiment. Note that the frequency ω₀ is not limited thereto, and the frequency ω₀ is simply required to be a value that approximates the rated frequency of the power system 1. Other examples of a value of the frequency ω₀ include an average value of frequency ω₀ of the power system 1 during a predetermined time period in a normal state, or the like.

In this way, setting the frequency ω₀, which is an initial value, can reduce the time period for time-integration in the operation processing by the integrator 213. This can reduce the difference between a system frequency and a command frequency when an inverter device is started to establish an interconnection with the system, thereby reducing the power fluctuation occurring at the time of establishing the interconnection.

### <Integrator 215>

The integrator 215 executes an operation of time-integration on the command frequency ωₒᵤₜ, which is an input from the addition unit 214. As a result of such an operation, the integrator 215 outputs the phase θ, which is a command value for the phase of the output power V_{abc} outputted from the drive unit 24.

### <Instantaneous Voltage Control Unit 22>

The instantaneous voltage control unit 22 of FIG. 2 generates a sinusoidal signal V_{abc}* as a fundamental wave in PWM control, based on the phase θ, which is an input from the integrator 215, and a command value for the amplitude of the output voltage V_{abc}. The sinusoidal signal V_{abc}* is outputted to the PWM pulse generation unit 23.

### <PWM Pulse Generation Unit 23>

The PWM pulse generation unit 23 detects an intersection between a carrier wave actualized by a triangular wave, for example, and a sine wave as a fundamental wave, which is an input from the instantaneous voltage control unit 22. As a result of the detection, the PWM pulse generation unit 23 determines the duty ratio of a PWM pulse and generates a PWM pulse V_{PWM} having the determined duty ratio.

The PWM pulse V_{PWM} is outputted to the drive unit 24 to drive an inverter circuit in the drive unit 24. Note that the PWM pulse V_{PWM} is an example of a “control signal”.

### <Drive Unit 24>

The drive unit 24 includes a direct-current power supply 240 and the inverter circuit (unillustrated) including a plurality of switching elements. The inverter circuit converts a direct current voltage from the direct-current power supply 240 to an alternating current voltage, and then outputs the alternating current voltage as the output voltage V_{abc} to the power system 1. At this time, the inverter circuit outputs the output voltage V_{abc} generated based on the PWM pulse, which is an output from the PWM pulse generation unit 23.

Note that the integrator 215, the instantaneous voltage control unit 22, and the PWM pulse generation unit 23 correspond to a “generation unit”. That is, the “generation unit” generates a control signal for controlling the output voltage V_{abc}, based on the command frequency ωₒᵤₜ.

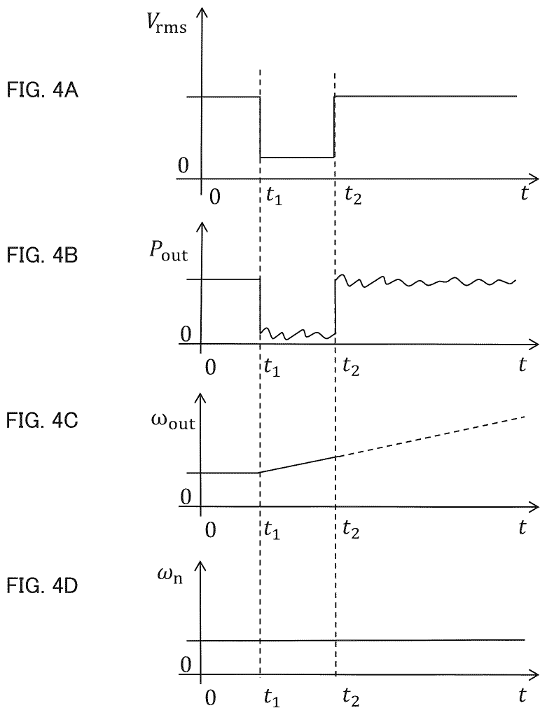

The configuration of the power supply device 2 has been described above. Next, a step-out possible to occur in the power supply device 2 will be described. FIG. 4 provides graphs illustrating a step-out in the power supply device 2.

In FIG. 4(A) to FIG. 4(D), the horizontal axis represents time t. In these graphs, a power system is in a normal state during a time period before the time t₁. Then, at the time t₁, an accident such as a ground fault accident or another accident occurs in the power system. At time t₂, the accident is eliminated. A time period after the time t₂ is a time period in a normal state.

FIG. 4(A) illustrates the variation of a voltage Vᵣₘₛ, which is the root mean square of the output voltage V_{abc} of a general power supply device. FIG. 4(B) illustrates the variation of the power Pₒᵤₜ that is a power being actually provided to or received from the power system by the general power supply device. FIG. 4(C) illustrates the variation of the command frequency ωₒᵤₜ. FIG. 4(D) illustrates the variation of the frequency ωₙ of the power system.

Note that, in this example, the power supply device 2 does not include a block that calculates the voltage Vᵣₘₛ, but can separately calculate the voltage Vᵣₘₛ from the output voltage V_{abc}, in accordance with the definition of the following expression.

The voltage Vᵣₘₛ is defined by the following expression.

$${V}_{r m s} = \sqrt{\frac{2}{3} ( {V}_{a}^{2} + {V}_{b}^{2} + {V}_{c}^{2} )}$$

Here, Vₐ, V_{b}, and V_{c} on the right side denote instantaneous values of the phase voltages of the respective phases in the three-phase alternating current.

As illustrated in FIG. 4(A), during a time period from the occurrence of the accident to the elimination of the accident (a time period from the time t₁ to the time t₂), the voltage Vᵣₘₛ drops compared to that in the normal time periods (the time period before the time t₁ and the time period after the time t₂).

With such a drop, as illustrated in FIG. 4(B), during the time period from the occurrence of the accident to the elimination of the accident, the power Pₒᵤₜ that is a power being provided to or received from the power system fluctuates at a low level. This is because, as the output voltage V_{abc} drops, the power Pₒᵤₜ obtained by multiplying the output voltage V_{abc} and the output current I_{abc} together also drops.

As illustrated in FIGS. 4(C) and 4(D), before the occurrence of the accident, the frequency ωₒᵤₜ of the output voltage V_{abc} is in a state of being synchronized with the frequency ωₙ of the power system, and the values of both frequencies are approximately equal to each other.

At the occurrence of the accident, the frequency ωₒᵤₜ of the output voltage V_{abc} starts to increase (FIG. 4(C)). This is because the power Pₒᵤₜ fluctuates at a low level as illustrated in FIG. 4(B) and hence the power Pᵢₙ*, which is a target power to be provided to or received from the power system, is deviated from the power Pₒᵤₜ. The details thereof will be described later. In contrast, the frequency ωₙ of +the power system varies in an approximate stable state even after the occurrence of the accident (FIG. 4(D)).

As described above, responsive to the occurrence of the accident in the power system, the frequency ωₒᵤₜ of the output voltage V_{abc} starts to be deviated from the frequency ωₙ of the power system. Such a deviation increases the phase difference between the power system and the output voltage V_{abc}. When this phase difference exceeds 180°, a state of being synchronized with the power system is collapsed, that is, a so-called out-of-synchronization (step-out) state is caused.

Once a step-out occurs, returning to the synchronized state is difficult in general even after the elimination of the accident. The frequency ωₒᵤₜ of the output voltage V_{abc} continues increasing (FIG. 4(C)). In contrast, the frequency On of the power system varies in an approximate stable state even after the elimination of the accident (FIG. 4(D)).

### <<Numerical Simulation Result>>

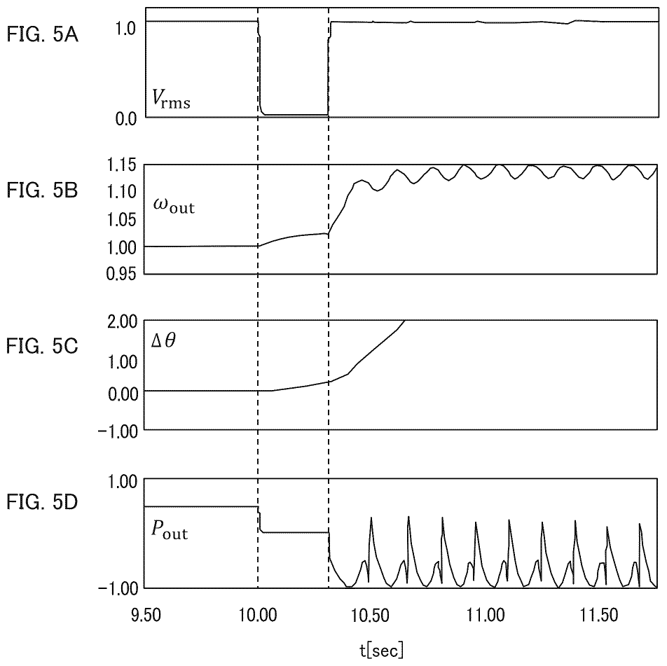

A numerical simulation assuming the case where the power supply device 2 had an interconnection with a power system was performed. By assuming the case where an accident had occurred in the power system having an interconnection with the power supply device 2, behavior of the power supply device 2 was investigated. FIG. 5 provides graphs illustrating a numerical simulation result assuming the power supply device 2.

In FIG. 5(A) to(D), the horizontal axis represents time t. In these graphs, a time period before t=10.00 [sec] is a time period during which the power system is in a normal state. At time t=10.00 [sec], an accident occurs in the power system. At time t=10.30 [sec], the accident is eliminated. Then, a time period after time t=10.30 [sec] is a time period during which the power system is in a normal state.

FIG. 5 (A) illustrates a calculation result of the variation of the voltage Vᵣₘₛ, which is the root mean square of the output voltage V_{abc}. FIG. 5 (B) illustrates a calculation result of the variation of the command frequency ωₒᵤₜ with respect to the output voltage V_{abc}. FIG. 5 (C) illustrates a calculation result of the variation of the phase difference Δθ between the phase of the output voltage V_{abc} and the phase of the power system. FIG. 5 (D) illustrates a calculation result of the variation of the power Pₒᵤₜ that is a power being provided to or received from the power system.

As illustrated in FIG. 5(A), during the time period from the occurrence of the accident to the elimination of the accident, the voltage Vᵣₘₛ drops to approximately 0 (zero).

The description will be given below separately for the time period before the occurrence of the accident, the time period from the occurrence of the accident to the elimination of the accident, and the time period after the elimination of the accident.

### Period Before Occurrence of Accident

As illustrated in FIG. 5 (A) to (D), during the time period before the occurrence of the accident, the output voltage V_{abc}, the command frequency ωₒᵤₜ, the phase difference Δθ, and the power Pₒᵤₜ each vary at an approximately constant value.

Period from Occurrence of Accident to Elimination of Accident

When the accident occurs, the frequency ωₒᵤₜ starts to increase (FIG. 5(B)). This is because, when the accident occurs, the power Pₒᵤₜ significantly decreases, and the difference (Pᵢₙ* −Pₒᵤₜ), which is a subtraction result from the subtraction unit 212, greatly fluctuates.

This consequently increases an integral value (Δω) from the integrator 213, which consequently increases the frequency ωₒᵤₜ.

When the accident occurs, the phase difference Δθ starts to increase (FIG. 5(C)). This is because the phase difference Δθ, which is the value obtained by time-integrating the difference caused by the frequency ωₒᵤₜ starting to be deviated from the frequency of the power system, increases along with a lapse of time.

When the accident occurs, the power Pout drops to approximately 0 (zero) (FIG. 5(D)). Such a drop occurs as the voltage Vᵣₘₛ drops to approximately 0 (zero) (i.e., the voltage V_{abc} also drops to approximately 0 (zero)) as illustrated in FIG. 5(A).

### Period After Elimination of Accident

Subsequently, when the accident is eliminated, the voltage Vᵣₘₛ is restored to the value before the occurrence of the accident (FIG. 5(A)).

When the accident is eliminated, the frequency ωₒᵤₜ further fluctuates. The frequency ωₒᵤₜ varies along with periodic oscillations around a frequency value higher than that before the occurrence of the accident (FIG. 5(B)).

That is, even when the accident is eliminated, the power supply device 2 does not return to the state of being synchronized with the power system before the occurrence of the accident, and falls into the step-out state.

When the accident is eliminated, the phase difference Δθ of the general power supply device further continues increasing (FIG. 5(C)). This is because the frequency ωₒᵤₜ is deviated from the frequency of the power system even after the accident is eliminated (FIG. 5(B)).

When the accident is eliminated, the power Pₒᵤₜ varies along with periodic fluctuations (FIG. 5(D)). At this time, an indication that the power Pₒᵤₜ is restored to the value before the occurrence of the accident cannot be found. As described above, from the result of the numerical simulation, it was found that a step-out may occur in the power supply device 2 responsive to the occurrence of the accident in the power system.

### <<Power Supply Device 3>>

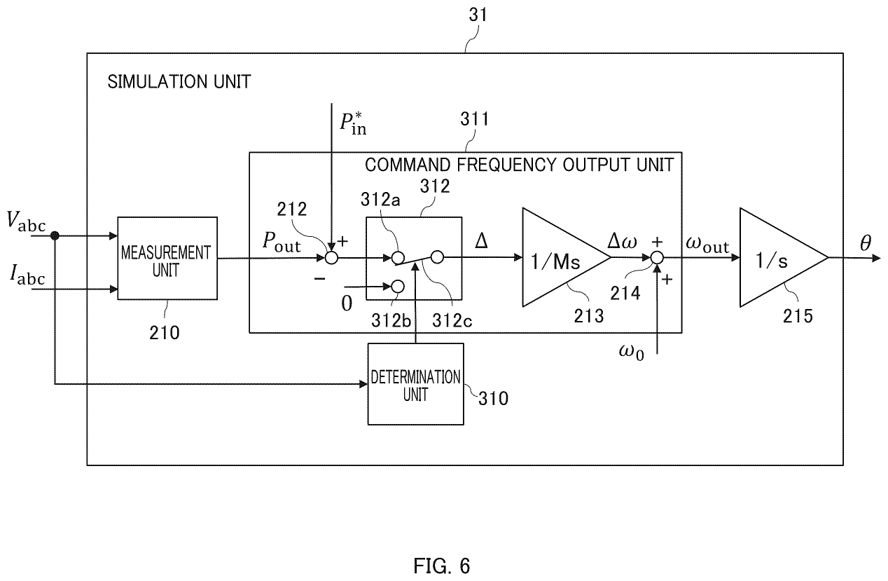

Next, a power supply device 3 of the present embodiment will be described. FIG. 6 is a diagram illustrating a simulation unit 31 of the power supply device 3 of the present embodiment. The power supply device 3 is different from the power supply device 2 (FIG. 2) only in a configuration of the simulation unit 31.

The simulation unit 31 includes the measurement unit 210, a determination unit 310, a command frequency output unit 311, and the integrator 215.

In the following, processing executed by each of the components in the simulation unit 31 will be described. The description of the configurations of the measurement unit 210 and the integrator 215, which are common to those of the power supply device 2, is omitted. The determination unit 310 and the command frequency output unit 311 will be described.

### <Determination Unit 310>

The determination unit 310 determines whether an accident occurs in the power system 1, based on the output voltage V_{abc} measured by the measurement unit 210, and then controls the output unit 312 depending on a determination result (which will be described later).

In the present embodiment, the determination unit 310 determines whether an accident occurs in the power system 1, based on the fluctuation of the voltage Vᵣₘₛ, which is the root mean square of the voltage of the power system 1.

Responsive to the occurrence of the accident in the power system 1, the voltage V_{abc} drops, and the voltage Vᵣₘₛ also drops accordingly. Hence, the fluctuation of the voltage Vᵣₘₛ can be regarded as an index indicating the degree of the accident.

For example, when a ground fault accident occurs, the resistance between a power line and the ground is reduced. Thus, the voltage V_{abc} drops. Accordingly, the voltage Vᵣₘₛ also drops. The larger the degree of the ground fault accident is, the more greatly the resistance between the power line and the ground is reduced. Thus, the voltage Vᵣₘₛ also drops greatly.

The means for determination by the determination unit 310 is not particularly limited. When the voltage Vᵣₘₛ at the current time is deviated from the average value of the voltages Vᵣₘₛ during a predetermined time period before the current time by a predetermined threshold or more, the determination unit 310 of the present embodiment is assumed to determine that an accident has occurred.

### <<Command Frequency Output Unit 311>>

When the power system 1 is in a normal state, the command frequency output unit 311 outputs a command frequency that reduces the difference between the power Pᵢₙ* (corresponding to a “first power”) and the power Pₒᵤₜ (corresponding to a “second power”), based on such a difference (Pᵢₙ*−Pₒᵤₜ).

Responsive to the occurrence of the accident in the power system 1, the command frequency output unit 311 outputs a predetermined command frequency irrespective of the difference between the power Pᵢₙ* and the power Pₒᵤₜ.

At this time, the command frequency output unit 311 outputs the predetermined command frequency that reduces the difference between the frequency of the power system 1 when the accident is eliminated and the command frequency. That is, at this time, the command frequency output unit 311 outputs the predetermined command frequency such that the frequency of the power system 1 and the command frequency ωₒᵤₜ are not significantly deviated from each other.

The command frequency output unit 311 includes the subtraction unit 212, an output unit 312, the integrator 213, and the addition unit 214. In the following, processing executed by each of the components in the command frequency output unit 311 will be described. The description of the configurations of the subtraction unit 212, the integrator 213, and the addition unit 214, which are the same as those of the power supply device 2, is omitted. The output unit 312 will be described.

### <Output Unit 312>

The output unit 312 outputs a value Δ, based on the determination result from the determination unit 310. The output unit 312 includes an input 312a, an input b, and a switch unit 312c.

The input 312a is connected to an output of the subtraction unit 212. Hence, the subtraction result (Pᵢₙ*−Pₒᵤₜ) from the subtraction unit 212 is inputted to the input 312a.

The input 312b is a terminal to which a predetermined value is inputted. Here, the “predetermined value” is more preferable as the absolute value is closer to 0 (zero). The “predetermined value” is most preferably 0 (zero) (or substantially 0 (zero)). The reason thereof will be described together with a numerical simulation result which will be described later. In the present embodiment, 0 (zero) is inputted to the input 312b.

The switch unit 312c is controlled by the determination unit 310. The switch unit 312c is connected to the input 312a in a normal state. When the determination unit 310 determines that an accident occurs, the determination unit 310 switches the switch unit 312c to the input 312b. When the determination unit 310 determines that an accident is eliminated, the determination unit 310 switches the switch unit 312c to the input 312a.

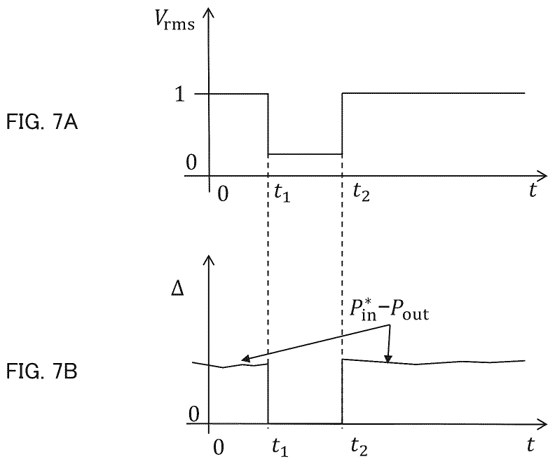

The value Δ that is outputted from the output unit 312 will be described with reference to FIG. 7. FIG. 7 provides graphs illustrating the value Δ that is outputted from the output unit 312. In these graphs, the horizontal axis represents time, and the vertical axis represents the value Δ that is outputted from the output unit 312.

In these graphs, a time period before time t₁ is a time period during which the power system 1 is in a normal state. At the time t₁, an accident occurs in the power system 1. At time t₂, the accident is eliminated. A time period after the time t₂ is a time period in a normal state.

When the power system 1 is in a normal state (the time period before the time t₁ and the time period after the time t₂), the switch unit 312c is connected to the input 312a. Hence, the output unit 312 outputs, to the integrator 213, the subtraction result (Pᵢₙ*−Pₒᵤₜ) from the subtraction unit 212, as the value Δ, as illustrated in FIG. 7.

In contrast, responsive to the occurrence of the accident in the power system 1 (the time period after the time t₁ and before the time t₂), the switch unit 312c is switched to the input 312b. Hence, the output unit 312 outputs, to the integrator 213, 0 (zero) as the value Δ, as illustrated in FIG. 7.

According to the configuration of the power supply device 3 described above, it is possible to prevent a step-out due to an accident occurring in a power system or the like.

### <<Numerical Simulation Result>>

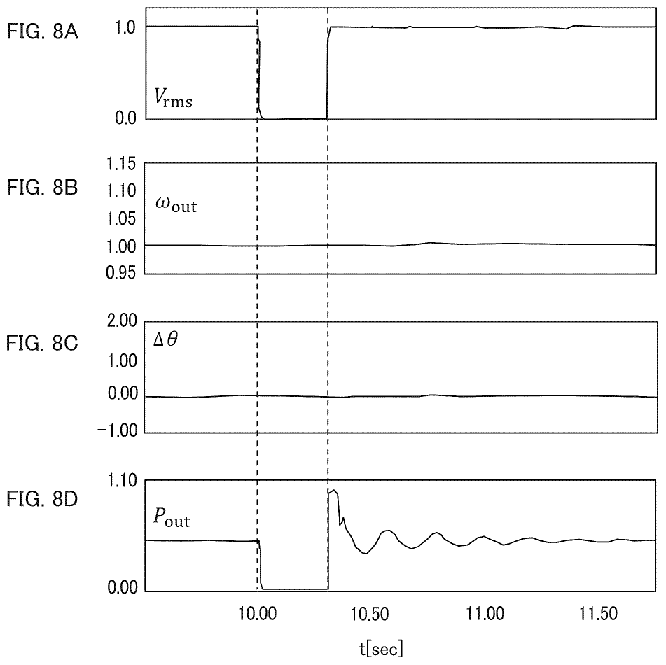

A numerical simulation assuming that the power supply device 3 had an interconnection with a power system was performed. By assuming the case where an accident had occurred in the power system having an interconnection with the power supply device 3, behavior of the power supply device 3 was investigated. FIG. 8 provides graphs illustrating a numerical simulation result assuming the power supply device 3.

In FIG. 8 (A) to (D), the horizontal axis and the vertical axis are similar to those in FIG. 5 illustrating the numerical simulation result for the power supply device 2. That is, in these graphs, a time period before t=10.00 [sec] is a time period during which the power system is in a normal state. At time t=10.00 [sec], an accident occurs in the power system. At time t=10.30 [sec], the accident is eliminated. Then, a time period after time t=10.30 [sec] is a time period during which the power system is in a normal state.

The description will be given below separately for the time period before the occurrence of the accident, the time period after the occurrence of the accident to the elimination of the accident, and the time period after the elimination of the accident.

### Period Before Occurrence of Accident

As illustrated in FIG. 8 (A) to (D), during the time period before the occurrence of the accident, the output voltage V_{abc}, the command frequency θₒᵤₜ, the phase difference Δθ, and the power Pₒᵤₜ each vary at an approximately constant value.

Period from Occurrence of Accident to Elimination of Accident

The frequency ωₒᵤₜ varies in a constant state at an approximately similar frequency to that before the occurrence of the accident (FIG. 8(B)). This is because, when the accident occurs, the value Δ, which is an output from the output unit 312, becomes 0 (zero).

In the time period during which the output from the output unit 312 is 0 (zero), the contribution of the integrator 213 to an integral value is 0 (zero). Hence, the frequency ωₒᵤₜ, which is an output from the addition unit 214, maintains the value immediately before the occurrence of the accident. Thus, even when the accident occurs, the frequency ωₒᵤₜ varies at a value approximately similar to that of the frequency of the power system.

The phase difference Δθ in the power supply device 3 varies in a constant state at a phase difference similar to that before the occurrence of the accident. This is because the frequency ωₒᵤₜ varies at a value approximately similar to that of the frequency of the power system and hence the difference is maintained at approximately 0 (zero), as described above. Consequently, the phase difference Δθ, which is a value obtained by integrating the difference with respect to time, varies at approximately 0 (zero).

When the accident occurs, the power Pₒᵤₜ drops to approximately 0 (zero) (FIG. 8(D)). Such a drop occurs as the voltage Vᵣₘₛ drops to approximately 0 (zero) (i.e., the voltage V_{abc} also drops to approximately 0 (zero)) as illustrated in FIG. 8(A).

Period after Elimination of Accident

Subsequently, when the accident is eliminated, the voltage Vᵣₘₛ is restored to the value before the occurrence of the accident (FIG. 8(A)).

The frequency ωₒᵤₜ varies in a constant state at a similar frequency to that before the occurrence of the accident. That is, even when the accident is eliminated, the power supply device 3 returns to a state approximately similar to the state of being synchronized with the power system before the occurrence of the accident (FIG. 8 (B)). This is because the frequency ωₒᵤₜ varies at a value approximately similar to that of the frequency of the power system even after the occurrence of the accident, as described above.

The phase difference Δθ varies in a constant state at a phase difference similar to that before the occurrence of the accident. This is because the command frequency ωₒᵤₜ is maintained at a rated frequency of the power system during the time period from the occurrence of the accident to the elimination of the accident ((FIG. 8(B))) and hence both phases vary at an approximately equal level during such a time period. That is, a synchronized state of the system voltage and the power supply device 3 is maintained.

The power Pₒᵤₜ significantly fluctuates immediately after the elimination of the accident (FIG. 8(D)). However, with an elapse of time, the power Pₒᵤₜ is gradually restored to the value before the occurrence of the accident, accompanied by damped oscillation.

As described above, from the result of the numerical simulation, it was found that the power supply device 3 can prevent a step-out when an accident has occurred in the power system.

### Second Embodiment

A power supply device 4 of the present embodiment will be described. The power supply device 4 is different from the power supply device 2 (FIG. 2) only in a configuration of a simulation unit 41.

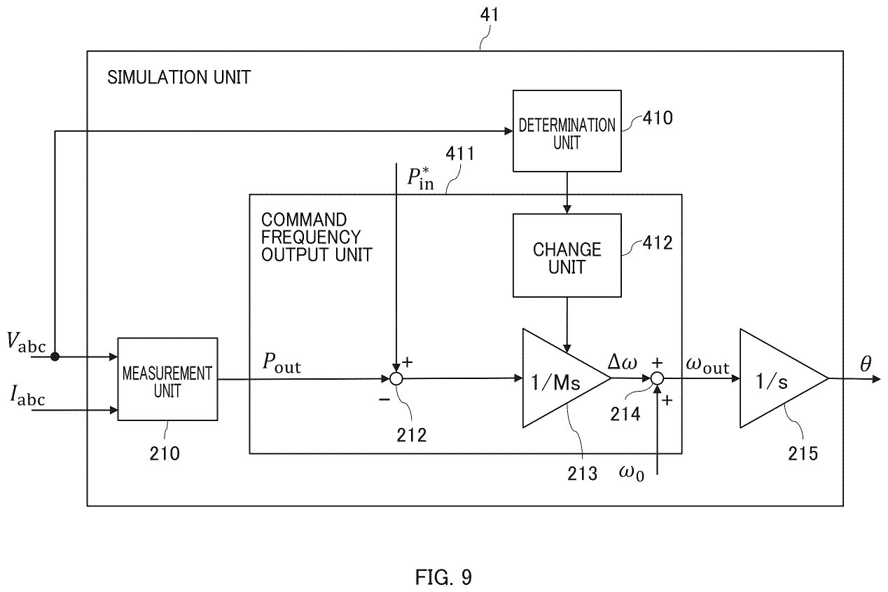

FIG. 9 is a diagram illustrating the simulation unit 41 of the present embodiment. The simulation unit 41 includes the measurement unit 210, a determination unit 410, a command frequency output unit 411, and the integrator 215.

In the following, processing executed by each of the components in the simulation unit 31 will be described. The description of the measurement unit 210 and the integrator 215, which are common to those in the first embodiment, is omitted.

### <Determination Unit 410>

The determination unit 410 determines whether an accident occurs in the power system 1, based on the output voltage V_{abc}, and outputs a determination result to a change unit 412 which will be described later.

Also in the present embodiment, similarly to the determination unit 310 of the first embodiment, the determination unit 410 determines whether an accident occurs in the power system 1, based on the fluctuation of the voltage Vᵣₘₛ, which is the root mean square of the voltage of the power system 1.

### <<Command Frequency Output Unit 411>>

The command frequency output unit 411 outputs a command frequency that reduces the difference between the power Pᵢₙ* and the power Pₒᵤₜ, based on the power Pᵢₙ*, the power Pₒᵤₜ, and the inertia constant M.

Responsive to the occurrence of the accident in the power system 1, the command frequency output unit 411 controls the inertia constant M to suppress a change of the command frequency.

The command frequency output unit 411 includes the subtraction unit 212, the change unit 412, the integrator 213, and the addition unit 214. In the following, processing executed by each of the components in the command frequency output unit 411 will be described. The description of the configurations of the subtraction unit 212, the integrator 213, and the addition unit 214, which are common to those of the power supply device 2, is omitted. The change unit 412 will be described.

### <Change Unit 412>

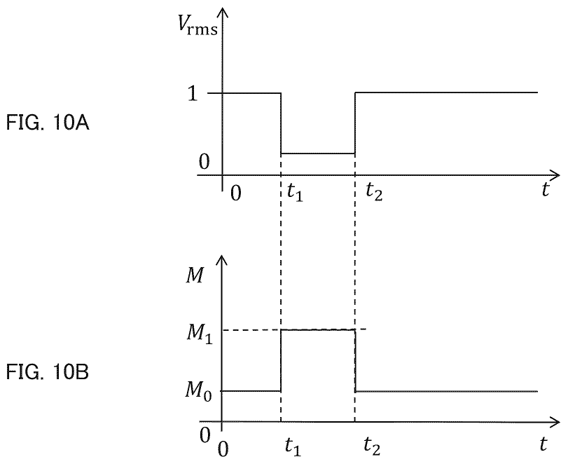

Responsive to the occurrence of the accident in the power system 1, the change unit 412 changes the inertia constant M used in the processing by the integrator 213 so as to be larger than that when the power system 1 is in a normal state. The variation of the inertia constant M with the processing by the change unit 412 will be described with reference to FIG. 10.

FIG. 10 provides graphs illustrating the variation of the inertia constant M. In these graphs, the horizontal axis represents time, and the vertical axis represents the value of the inertia constant M.

In these graphs, a time period before time t₁ is a time period during which the power system 1 is in a normal state. At the time t₁, an accident occurs in the power system 1. At time t₂, the accident is eliminated. Then, a time period after the time t₂ is a time period in a normal state.

When the power system 1 is in a normal state (the time period before the time t₁ and the time period after the time t₂), the value of the inertia constant M is an initial setting value M₀. The initial setting value M₀ is a value corresponding to an inertia moment of a rotor included in a synchronous generator, for example.

Responsive to the occurrence of the accident in the power system 1 (the time period after the time t₁ and before the time t₂), the change unit 412 changes the value of the inertia constant M to a value M₁ that is larger than the initial setting value M₀. When the accident is eliminated, the change unit 412 returns the value of the inertia constant M to the initial setting value M₀.

At this time, it is preferable that M₁ is as large as possible compared with M₀. M₁ is preferably set as large as possible within a range where an unstable result in terms of numerical calculation is not outputted.

As a result, the contribution of the integrator 213 to an integral value is reduced in a time period during which the value of the inertia constant M is M₁. In particular, when M₁ is substantially infinite, the contribution of the integrator 213 to an integral value is substantially 0 (zero).

Hence, the frequency ωₒᵤₜ, which is an output from the addition unit 214, does not significantly increase or decrease even when an accident occurs. In particular, when M₁ is substantially infinite, the frequency ωₒᵤₜ maintains the value immediately before the occurrence of the accident.

As described in the description of the numerical simulation of the first embodiment, when an accident occurs and the command frequency ωₒᵤₜ significantly increases or decreases, a step-out is likely to occur. However, changing the value of the inertia constant M as in the present embodiment can prevent a step-out.

Note that the integrator 213 and the addition unit 214 described above are collectively referred to as a “second output unit”. The “second output unit” outputs the command frequency ωₒᵤₜ depending on a subtraction result from the subtraction unit 212, based on the subtraction result from the subtraction unit 212 and the inertia constant M.

The power supply device 4 of the present embodiment described above can prevent a step-out when an accident occurs in the power system 1.

### Third Embodiment

A power supply device 5 of the present embodiment will be described. The power supply device 5 is different from the power supply device 2 only in a configuration of the simulation unit 51.

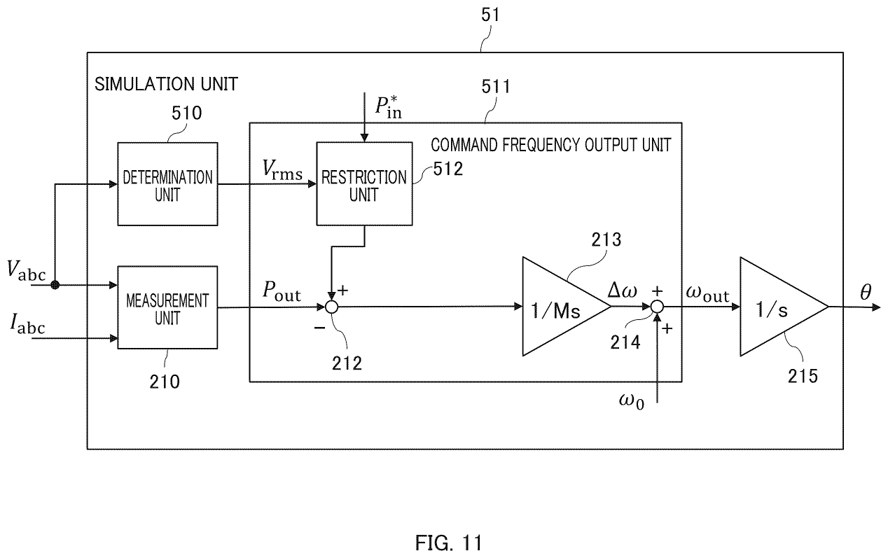

FIG. 11 is a diagram illustrating the simulation unit 51 of the present embodiment. The simulation unit 51 includes the measurement unit 210, a determination unit 510, a command frequency output unit 511, and the integrator 215.

In the following, processing executed by each of the components in the simulation unit 51 will be described. The description of the measurement unit 210 and the integrator 215, which are common to those in the first embodiment, is omitted.

### <Determination Unit 510>

The determination unit 510 determines whether an accident occurs in the power system 1, based on the output voltage V_{abc}, and outputs determination result to restriction unit 512 which will be described later.

Also in the present embodiment, similarly to the the first embodiment, the determination unit 310 of determination unit 510 determines whether an accident occurs in the power system 1, based on the fluctuation of the voltage Vᵣₘₛ, which is the root mean square of the voltage of the power system 1.

### <<Command Frequency Output Unit 511>>

The command frequency output unit 511 outputs the command frequency ωₒᵤₜ that reduces the difference between the power Pᵢₙ* and the power Pₒᵤₜ, based on the power Pᵢₙ*, the power Pₒᵤₜ, and the inertia constant M.

Responsive to the occurrence of the accident in the power system 1, the command frequency output unit 511 controls the power Pᵢₙ* to suppress a change of the command frequency ωₒᵤₜ.

The command frequency output unit 511 includes the subtraction unit 212, the restriction unit 512, the integrator 213, and the addition unit 214. In the following, processing executed by each of the components in the command frequency output unit 511 will be described. The description of the configurations of the subtraction unit 212, the integrator 213, and the addition unit 214, which are common to those of the power supply device 2, is omitted. The restriction unit 512 will be described.

### <Restriction Unit 512>

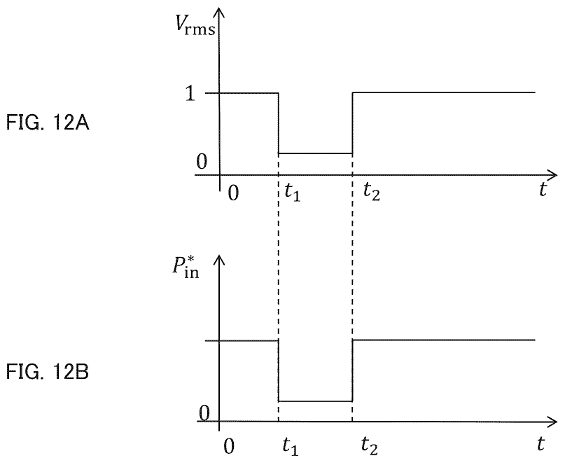

The restriction unit 512 receives, as inputs, the power Pᵢₙ* and Vᵣₘₛ from the determination unit 510. When the power system 1 is in a normal state, the restriction unit 512 outputs the power Pᵢₙ* to the subtraction unit 212. Responsive to the occurrence of the accident in the power system 1, the restriction unit 512 outputs the power Pᵢₙ* obtained by restricting the power Pᵢₙ* to be low depending on the degree of the accident, to the subtraction unit 212. A value that is outputted from the restriction unit 512 will be described with reference to FIG. 12.

FIG. 12 provides graphs illustrating the value that is outputted from the restriction unit 512. In these graphs, the horizontal axis represents time, and the vertical axis represents the value that is outputted from the restriction unit 512.

In these graphs, a time period before time t₁ is a time period during which the power system 1 is in a normal state. At the time t₁, an accident occurs in the power system 1. At the time t₂, the accident is eliminated. Then, a time period after the time t₂ is a time period in a normal period.

When the power system 1 is in a normal state (the time period before the time t₁ and the time period after the time t₂), the restriction unit 512 outputs the input power Pᵢₙ* without change.

In contrast, when an accident occurs in the power system 1 (the period after the time t₁ and before the time t₂), the restriction unit 512 outputs the power Pᵢₙ* obtained by restricting the inputted power Pᵢₙ* to be low.

As described in the first embodiment, the fluctuation of the voltage Vᵣₘₛ can be regarded as an index indicating the degree of the accident. Responsive to the occurrence of the accident in the power system 1, the degree at which the restriction unit 512 restricts the power Pᵢₙ* increases as the fluctuation of the voltage Vᵣₘₛ is larger.

An example of the degree at which the restriction unit 512 restricts the power Pᵢₙ* will be described.

As described above, when the voltage Vᵣₘₛ at the current time is deviated from the average value of the voltages Vᵣₘₛ during a predetermined time period before the current time by a predetermined threshold or more, the determination unit 510 is assumed to determine that an accident has occurred, similarly to the determination unit 310 of the first embodiment.

In the present embodiment, the case where the threshold is 50% of the average value of the voltage Vᵣₘₛ will be described as an example. That is, when the voltage Vᵣₘₛ falls below 50% of the average value, the determination unit 510 determines that an accident occurs.

Note that, in FIG. 12(A), the voltage Vᵣₘₛ on the vertical axis is normalized such that 100% of the average value of the voltage Vᵣₘₛ is represented as 1.

Based on the above-described assumption, when the voltage Vᵣₘₛ drops to a value corresponding to 90% of the average value, for example, the determination unit 510 does not determine that an accident has occurred. In this case, the restriction unit 512 outputs the inputted power Pᵢₙ* without change.

In contrast, when the voltage Vᵣₘₛ drops to a value corresponding to 10% of the average value, for example, the determination unit 510 determines that an accident has occurred. In this case, the restriction unit 512 outputs, as the restricted power Pᵢₙ*, a value corresponding to 10% of the inputted power Pᵢₙ*.

As described above, when the value of the power Pᵢₙ* is restricted, the difference between the power Pₒᵤₜ and the restricted power Pᵢₙ*, which is an output from the subtraction unit 212, becomes smaller than the difference between the power Pₒᵤₜ and the power Pᵢₙ* that is not restricted.

Consequently, Δω, which is an operation result from the integrator 213, becomes smaller than that in the case where the power Pᵢₙ* is not restricted. In addition, the deviation of the command frequency ωₒᵤₜ from the frequency of the power system is smaller than that in the case where the power Pᵢₙ* is not restricted.

Accordingly, a significant increase or decrease of the command frequency ωₒᵤₜ can be suppressed when an accident occurs in the power system 1, which can consequently prevent a step-out.

Note that the integrator 213 and the addition unit 214 described above are collectively referred to as a “first output unit”. The “first output unit” outputs a command frequency that reduces the difference (Pᵢₙ*−Pₒᵤₜ) between the power Pᵢₙ* outputted from the restriction unit 512 and the power Pₒᵤₜ, based on such a difference.

The power supply device 5 of the present embodiment described above can prevent a step-out when an accident occurs in the power system 1.

Note that, there is no limitation on the aspect of the power supply device 5 of the present embodiment. The power supply device 5 may further include the determination unit 410 and the change unit 412 of the second embodiment. With such a configuration, a step-out can be further efficiently prevented when an accident occurs in the power system 1.

### Fourth Embodiment

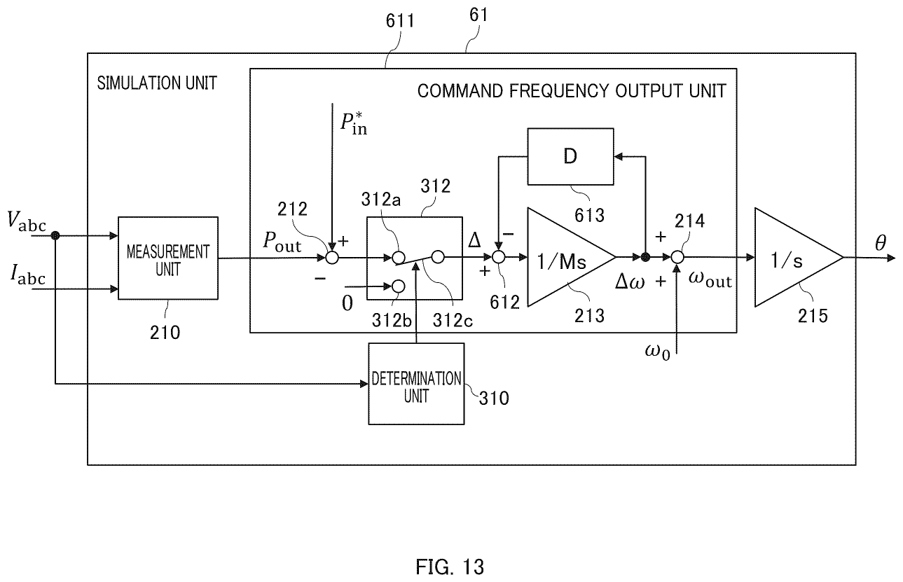

FIG. 13 is a diagram illustrating a simulation unit 61 of the present embodiment. The simulation unit 61 includes the measurement unit 210, a command frequency output unit 611, and the integrator 215. A power supply device 6 is different from the power supply device 3 (FIG. 6) of the first embodiment only in a configuration of the command frequency output unit 611.

The command frequency output unit 611 is different from the command frequency output unit 311 (FIG. 6) of the power supply device 3 of the first embodiment in that the command frequency output unit 611 further includes a subtraction unit 612 and a multiplier 613.

The configurations of the subtraction unit 612 and the multiplier 613 in the command frequency output unit 611 will be described below. The configurations other than the subtraction unit 612 and the multiplier 613 are common to those of the first embodiment, and thus, detailed description thereof is omitted.

### <Subtraction Unit 612>

The subtraction unit 612 executes processing of subtracting an output of the multiplier 613 (which will be described later in detail) from A, which is an output from the output unit 312, and outputs the resultant to the integrator 213.

### <Multiplier 613>

The multiplier 613 executes an operation of multiplying Δω, which is an output from the integrator 213, by a damping constant D, and outputs the resultant to the subtraction unit 612.

The damping constant D is a parameter indicating the effect of damping when a rotational speed of a rotor in a synchronous generator that is simulated by the simulation unit 61 includes vibration or deviation from a rotational frequency ω₀. That is, the larger the damping constant D is, the more likely the rotational frequency of the rotor converges on ω₀.

As described above, the command frequency output unit 311 of the power supply device 3 of the first embodiment further includes the subtraction unit 612 and the multiplier 613, which can achieve the effect of damping of the vibration in rotation of the rotor in the synchronous generator.

The power supply device 6 of the present embodiment described above can prevent a step-out when an accident occurs in the power system 1.

### Conclusion

As described above, the power supply device 3 of the above-described first embodiment is a power supply device that simulates a synchronous generator including a rotor and controls a frequency of an output voltage, to control a power provided to or received from the power system 1. The power supply device 3 includes: the determination unit 310 configured to determine whether an accident has occurred in the power system 1;
the command frequency output unit 311 configured to:
   output a command frequency that reduces a difference between a first power that is a target power to be provided to or received from the power system 1 and a second power that is a power being provided to or received from the power system 1, based on the difference, when the power system 1 is in a normal state; and
   output, irrespective of the difference, a predetermined command frequency of the command frequency, responsive to the occurrence of the accident in the power system 1;
the generation unit configured to generate a control signal for controlling the output voltage, based on the command frequency; and
the drive unit 24 configured to output the output voltage generated based on the control signal, to the power system.

With such a configuration, during a time period from the occurrence of an accident to the elimination of the accident, the frequency that is outputted from the command frequency output unit 311 is not significantly reduced. Thus, at a time of the elimination of the accident, a command value of the phase of the output voltage V_{abc} is not significantly deviated from the phase of the power system. Hence, it is possible to prevent a step-out due to an accident occurring in the power system 1 or the like.

In the power supply device 3 of the first embodiment, the command frequency output unit 311 outputs, responsive to the occurrence of the accident, the predetermined command frequency that reduces the difference between the command frequency and the frequency of the power system 1 when the accident is eliminated, during a time period from the occurrence of the accident to the elimination of the accident. With such a configuration, during a time period from the occurrence of an accident to the elimination of the accident, the command frequency can be maintained at a value close to that of the frequency of the power system. Thus, after the elimination of the accident, a command value of the phase of the output voltage V_{abc} varies at a value close to that of the phase of the power system 1. Hence, it is possible to further effectively prevent a step-out due to the occurrence of an accident in the power system 1 or the like.

In the power supply device 3 of the first embodiment, the command frequency output unit 311 includes:
the subtraction unit configured to subtract the second power from the first power; and
the output unit configured to:
   output the command frequency depending on a subtraction result from the subtraction unit, based on the subtraction result and an inertia constant for simulating the rotor, when the power system 1 is in the normal state: and
   output the predetermined command frequency, responsive to the occurrence of the accident in the power system 1. With such a configuration, the command frequency can be outputted with an easy calculation.

Each of the power supply devices 4 and 5 of the second and third embodiments is a power supply device that simulates a synchronous generator including a rotor and controls a frequency of an output voltage, to control a power provided to or received from the power system 1. The power supply device 4, 5 includes:
the determination units 410, 510 configured to determine whether an accident occurs in the power system 1;
the command frequency output units 411, 511 configured to output a command frequency that reduces a difference between a first power that is a target power to be provided to or received from the power system and a second power that is a power being provided to or received from the power system, based on the first power, the second power, and an inertia constant for simulating the rotor;
the generation unit configured to generate a control signal for controlling the output voltage, based on the command frequency; and
the drive unit 24 configured to output the output voltage generated based on the control signal, to the power system 1. The command frequency output units 411, 511 are configured to control, responsive to the occurrence of the accident in the power system 1, at least one of the first power and the inertia constant to suppress change of the command frequency.

With such a configuration, during a time period from the occurrence of an accident to the elimination of the accident, the frequency outputted from the command frequency output units 411, 511 are not significantly increased or reduced. Thus, at the time of the elimination of the accident, a command value of the phase of the output voltage V_{abc} is not significantly deviated from the phase of the power system 1. Hence, it is possible to prevent a step-out due to the occurrence of an accident in the power system 1 or the like.

In the power supply device 5 of the third embodiment,
the command frequency output unit 511 includes:
   output the first power when the power system 1 is in a normal state; and
   output the first power obtained by restricting the first power to be low depending on a degree of the accident, responsive to the occurrence of the accident in the power system 1; and
the first output unit configured to output, based on the difference between the first power output from the restriction unit 512 and the second power, the command frequency that reduces the difference. With such a configuration, the command frequency can be outputted with an easy calculation.

In the power supply device 4 of the second embodiment, the command frequency output unit 411 includes:
the subtraction unit configured to subtract the second power from the first power;
the second output unit configured to output, based on a subtraction result from the subtraction unit and the inertia constant, the command frequency that reduces the subtraction result; and
the change unit 412 configured to change, responsive to the occurrence of the accident in the power system 1, the inertia constant to be larger than an inertia constant when the power system 1 is in a normal state. With such a configuration, the command frequency can be outputted with an easy calculation.

In each of the power supply devices 3, 4, 5, and 6 of the first to fourth embodiments, the determination units 310, 410, 510 are configured to determine whether an accident has occurred in the power system 1, based on the fluctuation of the root mean square of the voltage of the power system 1. Such a configuration improves the accuracy of determination about whether an accident has occurred in the power system 1.

1. A power supply device that simulates a synchronous generator including a rotor and controls a frequency of an output voltage thereof to control a power provided to or received from a power system, the power supply device comprising:
a processor, and
a non-transitory storage medium having program instructions stored thereon, execution of which by the processor causes the power converter to provide functions of:
a determination unit configured to determine whether an accident occurs in the power system;
a command frequency output unit configured to:
output a command frequency that reduces a difference between
a first power that is a target power to be provided to or received from the power system, and
a second power that is a power being provided to or received from the power system,
when the power system is in a normal state, and
output, irrespective of the difference, a predetermined command frequency, responsive to an occurrence of the accident in the power system;
a generation unit configured to generate a control signal for controlling the output voltage, based on an output of the command frequency output unit; and
a drive unit configured to generate the output voltage based on the control signal.

2. The power supply device according to claim 1, wherein
the command frequency output unit is configured to determine the predetermined command frequency based on a rated frequency of the power system, for reducing a difference between the command frequency and a frequency of the power system when the accident is eliminated.

3. The power supply device according to claim 2, wherein the command frequency output unit includes:
a subtraction unit configured to subtract the second power from the first power, and
an output unit configured to:
output the command frequency based on a subtraction result from the subtraction unit and an inertia constant for simulating the rotor, when the power system is in the normal state, and
output the predetermined command frequency responsive to the occurrence of the accident in the power system.

4. A power supply device that simulates a synchronous generator including a rotor and controls a frequency of an output voltage thereof, to control a power provided to or received from a power system, the power supply device comprising:
a processor, and
a non-transitory storage medium having program instructions stored thereon, execution of which by the processor causes the power converter to provide functions of:
a determination unit configured to determine whether an accident occurs in the power system;
a command frequency output unit configured to:
output a command frequency that reduces a difference between
a first power that is a target power to be provided to or received from the power system, and
a second power that is the power being provided to or received from the power system,
based on the first power, the second power, and an inertia constant for simulating the rotor;
a generation unit configured to generate a control signal for controlling the output voltage, based on the command frequency; and
a drive unit configured to generate the output voltage based on the control signal, and to output the output voltage to the power system, wherein
the command frequency output unit is configured to control, responsive to an occurrence of the accident in the power system, at least one of the first power and the inertia constant, to suppress a change of the command frequency.

5. The power supply device according to claim 4, wherein the command frequency output unit includes:
a restriction unit configured to:
output the first power when the power system is in a normal state; and
responsive to the occurrence of the accident in the power system, restrict the first power depending on a degree of the accident, and output the restricted first power; and
a first output unit configured to obtain the command frequency to reduce the difference between the first power that is outputted from the restriction unit and the second power, and to output the command frequency.

6. The power supply device according to claim 4, wherein the command frequency output unit includes:
a subtraction unit configured to subtract the second power from the first power,
a second output unit configured to obtain the command frequency to reduce a subtraction result from the subtraction unit, based on the subtraction result and the inertia constant, and to output the command frequency; and
a change unit configured to increase the inertia constant, responsive to the occurrence of the accident in the power system.

7. The power supply device according to claim 1, wherein
the determination unit is configured to determine whether the accident occurs in the power system, based on a fluctuation of a root mean square of a voltage of the power system.
